(19) United States
(12) Patent Application Publication
(10) Pub. No.: US 2019/0248106 A1
(43) Pub. Date: Aug. 15, 2019

(54) MULTILAYER HYBRID COMPOSISTE

(71) Applicant: DSM IP Assets B.V., Heerlen (NL)

(72) Inventors: Johannes Petrus Marinus PLUG, Echt (NL); Roelof MARISSEN, Echt (NL); Timothy James KIDD, Echt (NL)

(21) Appl. No.: 16/313,682

(22) PCT Filed: Jun. 29, 2017
(86) PCT No.: PCT/EP2017/066142

§ 371 Date: Dec. 27, 2018

(30) Foreign Application Priority Data
Jul. 1, 2016 (EP) 16177536.6
Jul. 4, 2016 (EP) 1617774.3

(51) Int. Cl. B32B 5/26; B32B 5/02; D03D 11/00

(52) U.S. Cl. CPC B32B 5/26; B32B 5/024; B32B 2260/046; B32B 2260/023; D03D 11/00

(57) ABSTRACT

The present invention relates to a multilayer hybrid composite comprising: i) at least one layer of a fabric A comprising from 0 to 20 vol % high performance polymer fibers, based on the total volume of the fabric A, and from 100 to 80 vol % fibers selected from the group consisting of glass fibers and carbon fibers, based on the total volume of the fabric A; ii) at least one layer of a fabric B comprising from 20 to 70 vol % high performance polymer fibers, based on the total volume of the fabric B, and from 80 to 20 vol % fibers selected from the group consisting of glass fibers and carbon fibers, based on the total volume of the fabric B; and iii) a matrix material, wherein the at least one layer of the fabric B is adjacent to the at least one layer of the fabric A, and wherein the concentration (vol %) of the high performance polymer fibers in the fabric B is higher than the concentration (vol %) of the high performance polymer fibers in the fabric A, and wherein the high performance polymer fibers have a tenacity of at least 1.5 N/tex.

The invention relates to a multilayer hybrid composite comprising high performance polymer fibers and fibers selected from a group consisting of glass fibers and carbon fibers. Furthermore, the invention also relates to an article comprising the multilayer hybrid composite. The invention also directs to the process for making the multilayer hybrid composite. The invention further relates to the use of the multilayer hybrid composite in different applications.

Such multilayer hybrid composite comprising high strength polyethylene fibers and carbon fibers is known in the art. For instance, document Effect of hybrid mode on CF/UHMWPEF composite performance by Zhang Yong-bing, Shi Jun-hu, Wang Li, 2^{nd} Issue of 2005, pages 17-19, in Fiber Reinforced Plastics and Composites discloses interlaced, sandwich and polylaminate fiber hybrid structures using carbon fiber (CF) and UHMWPE fiber (UHMWPEF). The interlaced hybrid structures disclosed in this document are fabrics made by weaving CF in warp direction and UHMWPEF in weft direction. The sandwich hybrid structures contain one layer of UHMWPEF in the middle layer and CF in the outside layers of the structures. The polylaminate structures were made by alternating a layer containing CF with a layer containing UHMWPEF in a composite structure containing a total of 5 layers, with the outside layers of the composite being made of CF. The volume ratios of CF/UHMWPEF in the composites disclosed in this document were 75/25 and 50/50. This document indicates that the interlaced structure had the optimal performance in tensile strength, the sandwich structure had the optimal performance in bending strength and the polylaminate had the optimal performance in impact strength, with the sandwich hybrid being the ideal construction.

Also, document Dyneema fibers in composites, the addition of special mechanical functionalities by R. Marissen, L. Smit, C. Snijder, in Advancing with composites 2005, Naples, Italy, Oct. 11-14, 2005 discloses different multilayer hybrid composites and analyses these composites for safety, vibration damping or penetration resistance. This document particularly discloses epoxy resin reinforced with glass fiber fabrics and combined with Dyneema®/glass hybrid fabrics containing 57% by volume of Dyneema®. Nonetheless, the multilayer hybrid composite structures disclosed in this document have the disadvantage that the layers delaminate as there are many adjacent glass fibers layers and the balance between structural strength and impact strength is not optimal. In addition, using Dyneema® fibers only in the outer layers results in an overall low amount of Dyneema® fibers in the composite, especially in the multilayer composite with a high number of layers (e.g. in thick composites). Higher amounts of Dyneema® in the outer layer may result in difficulty in bonding other objects to the multilayer composite product.

However, there is a need in industry for a multilayer composite that has an improved balance between structural strength and impact strength, and shows little or no delamination between the layers of the composite.

The objective of the present invention is therefore to provide a composite that shows an improved balance between structural strength, stiffness and impact strength, and shows little or no delamination between the layers of the composite.

This objective was achieved by a multilayer hybrid composite comprising: i) at least one layer of a fabric A comprising from 0 to 20 vol % high performance polymer fibers, based on the total volume of the fabric A, and from 100 to 80 vol % fibers selected from the group consisting of glass fibers and carbon fibers, based on the total volume of the fabric A; ii) at least one layer of a fabric B comprising from 20 to 70 vol % high performance polymer fibers, based on the total volume of the fabric B, and from 80 to 30 vol % fibers selected from the group consisting of glass fibers and carbon fibers, based on the total volume of the fabric B; and iii) a matrix, wherein the at least one layer of the fabric B is adjacent to the at least one layer of the fabric A, and the concentration (vol %) of the high performance polymer fibers in the fabric B is higher than the concentration (vol %) of the high performance polymer fibers in the fabric A, and the high performance polymer fibers have a tenacity of at least 1.5 N/tex.

Surprisingly, the components of the multilayer hybrid composites according to the present invention show a synergistic effect in obtaining an improved combination of structural strength, stiffness and impact strength properties and optimal balance between these properties for the multilayer composite, said composite also showing little or no delamination between the layers. In addition, bonding of the multilayer hybrid composite according to the present invention to other objects is better.

It is true that document U.S. Pat. No. 4,983,433A discloses a layered hybrid composite comprising a) a first reinforced resin layer comprising a woven or knitted fabric comprising two kinds of filaments, i.e. UHMWPE filaments occupying 60 to 90% of the total surface area of said fabric and inorganic fibers occupying 60 to 90% of the total back surface area of said fabric, and a matrix resin and b) a second reinforced resin layer reinforced with an inorganic fiber and a matrix resin, the inorganic fibers being carbon or glass fibers. However, this document teaches that one fiber type should abundantly be present at one side of the fabric, i.e. occupying 60 to 90% of the total surface area of said fabric and the other fiber type should be present abundantly at the other side of the fabric, i.e. occupying 60 to 90% of the total back surface area of said fabric, forming a type of fabric that may be called asymmetric. FIG. 1 in U.S. Pat. No. 4,983,433 illustrates such an asymmetric type of fabric. This specific layered composite construction disclosed in this document causes delamination planes at the location where polymer fiber is abundant.

By term “multilayer” composite is herein understood a composite comprising two or more layers.

By term “hybrid” composites is herein understood a composite comprising at least two different kind of fibers, whereas the fibers have different chemical structure and properties.

By term “composite” is herein understood a material comprising fibers and a matrix material. The matrix material is typically a resin, preferably a polymeric resin that may be in fluid form and is impregnated in-between the fibers and optionally subsequently hardened. Hardening or curing may be done by any means known in the art, e.g. a chemical reaction, or by solidifying from molten to solid state.

By “fiber” is herein understood an elongated body having a length, a width and a thickness, with the length dimension of said body being much greater than the transverse dimensions of width and thickness. The fibers may have continuous lengths, known in the art as filaments, or discontinuous lengths, known in the art as staple fibers. The fibers may have various cross-sections, e.g. regular or irregular cross-sections with a circular, bean-shape, oval or rectangular shape and they can be twisted or non-twisted. The fibers may be used as untreated or they may be treated before using them in making fabrics; for instance, the high strength polyethylene fibers, in particular UHMWPE fibers may be treated by applying corona treatment or plasma treatment or by chemically modifying them, all these techniques being known to the skilled person in the art.

By “yarn” is herein understood an elongated body containing a plurality of fibers or filaments, i.e. at least two individual fibers or filaments. By individual fiber or filament is herein understood the fiber or filament as such. The term “yarn” includes continuous filament yarns or filament yarns which contain a plurality of continuous filament fibers and staple yarns or spun yarns containing short fibers also called staple fibers. Such yarns are known to the skilled person in the art.

By “warp yarns” is generally understood the yarns that run substantially lengthwise, in the length of the machine direction of the fabric. In general, the length direction is only limited by the length of the warp yarns whereas the width of a fabric is mainly limited by the number of individual warp yarns (that also may referred interchangeably herein to as number of pitches) and the width of the weaving machine employed.

By “weft yarns” is generally understood the yarns that run in a cross-wise direction, transverse to the machine direction of the fabric. Defined by a weaving sequence of the product, the weft yarn repeatedly interlaces or interconnects with said warp yarns. The angle formed between the warp yarns and the weft yarns can have any value and preferably about 90° or 45° or 30°. The woven fabrics may comprise one single weft yarn or multiple weft yarns with similar or different composition. The weft yarn can be one single weft yarn or a plurality of weft yarns.

The fabrics A and/or B can be any type of fabrics known in the art, for instance they may be woven, non-woven, knitted, netted, braided and/or technical fabrics. These types of fabrics and way of making them are already known to the skilled person in the art. Suitable examples of woven fabrics include plain (tabby) weaves, twill weaves, basket weaves, satin weaves, crow feet weaves, and triaxial weaves. Suitable examples of non-woven fabrics include unidirectional (UD) fibers, stitched fibers, veil and continuous strand mat.

For instance, the non-woven fabrics may be unidirectional non-woven fabrics, also known in the art as non-crimp UD fabrics. In this case, the fabric layers A and/or B in the multilayer hybrid composite according to the present invention may be formed by mono-layers, also known as plies that may alternatively contain an array of unidirectionally (UD) arranged polymeric fibers, i.e. fibers running along a common direction. Preferably, the fibers partially overlap along their length. The common direction of the fibers in one monolayer may be under an angle with the common direction of the fibers in the adjacent monolayer, e.g. said angle may be about 0°, 30°, 90° or 45°. The fibers may be subjected to pressure, preferably at a temperature below the melting temperature (Tm) of the polymer as determined by DSC, to form a layer of UD fabric A or B. The UD fabric made from fibers can be a non-woven fabric. Any coating applied thereof can mix or fuse with the matrix material c) in the composites according to the present invention and can be considered as part of the matrix material c) in the final multilayer hybrid composite. The UD sheets finally formed may be then cut to size and laid down in unidirectional layers in multiple orientations to form a two-directional fiber reinforced sheet, e.g. 0°/90°, +45°/−45°, +30°/−30° or a four directional non-woven fiber reinforced sheet, e.g. 0°/90°/45°/−45°, 0°/90°/30°/−30°, or other oriented non-woven fiber reinforced sheet with many orientations and layer combinations. Such UD sheets are for instance disclosed in document WO2014047227A1, incorporated herein by reference.

Preferably, fabrics A and B are woven fabrics, even more preferably fabrics A and B are woven fabrics having a plain weave, a twill weave, a basket weave or a satin weave. Preferably, fabrics A and/or B comprise fibers having a rounded cross-section, said cross section having an aspect ratio length (L):diameter (D) of at most 4:1, more preferably at most 2:1.

The woven fabrics A and B in the composite according to the present invention typically comprise, preferably consist of weft yarns and warp yarns. A fabric can be considered to be a three-dimensional object wherein one dimension (the thickness) is much smaller than the two other dimensions (the length or the warp direction and the width or weft direction). The position of the warp yarns is defined according to their position across the thickness of the fabric, whereby the thickness is delimited by an outside and an inside surface. By ‘outside’ and ‘inside’ is herein understood that the fabric comprises two distinguishable surfaces. The terminology ‘outside’ and ‘inside’ should not be interpreted as a limiting feature rather than a distinction made between the two different surfaces. It may as well be that for specific uses the surfaces will be facing the opposite way or that the fabric is folded to form a double layer fabric with two identical surfaces exposed on either side while the other surfaces are turned towards each other.

The weave structure formed by the warp yarns and the weft yarns in the woven fabrics A and B can be of multiple types, as known in the art, depending upon the number and diameters of the employed warp yarns and weft yarns as well as on the weaving sequence used between the warp yarns and the weft yarns during the weaving process. Such different sequences are well known to the person skilled in the art. Through the weaving process, the weft yarn interweaves the warp yarns, hereby partially interconnecting the outside and inside layers comprising respectively said warp yarns. Such interweaved structure may also be called a monolayer fabric even though such monolayer may be composed of sub layers as described above. Preferably, the woven structure of said monolayers is a plain weave, a twill weave, or a basket weave. Preferably, the weft direction in a monolayer of the woven fabrics A and/or B is under any angle with the weft direction of an adjacent monolayer. Preferably, said angle is about 30°, 45° or 90°.

A weave structure is typically characterized by a float, a length of the float and a float ratio. The float is a portion of a weft yarn delimited by two consecutive points where the weft yarn crosses the virtual plane formed by the warp yarns. The length of the float expresses the number of warp yarns that the float passes between said two delimiting points. Typical lengths of floats may be 1, 2 or 3, indicating that the weft yarn passes 1, 2 or 3 warp yarns before crossing the virtual plane formed by the warp yarns by passing between adjacent warp yarns. The float ratio is the proportion between the lengths of the floats of the weft yarn on either side of the plane formed by the warp yarns. Typically, the weave structure of the outside layer has float ratios of 3/1, 2/1 or 1/1. The weave structure for the inside layer may be chosen independent form the outside layer. For instance, depending upon the composition of the warp yarns and the weft yarns the weave structure of the inside layer may have a float ratios of 3/1, 2/1 or 1/1.

In the context of the present invention, the expression ‘substantially consisting of’ or “substantially consists of” has the meaning of ‘may comprise traces of further species’ or in other words ‘comprising more than 98 vol % of’, based on the total volume composition and hence allows for the presence of up to 2 vol % of further species, such as additives as described also herein.

The fabric A in the multilayer hybrid composite according to the present invention comprises from 0 to 20 vol % high performance polymer fibers, based on the total volume of the fabric A. Higher amount high performance polymer fibers leads to lower flexural strength. Preferably, the fabric A in the multilayer hybrid composite according to the present invention comprises at most 10 vol % high performance polymer fibers, based on the total volume of the fabric A, more preferably 0 vol % high performance polymer fibers, based on the total volume of the fabric A.

The fabric A in the multilayer hybrid composite according to the present invention comprises from 100 to 80 vol % fibers selected from the group consisting of glass fibers and carbon fibers, based on the total volume of the fabric A. Preferably, the fabric A in the multilayer hybrid composite according to the present invention comprises at least 90 vol % fibers selected from the group consisting of glass fibers and carbon fibers, based on the total volume of the fabric A, more preferably 100 vol % fibers selected from the group consisting of glass fibers and carbon fibers, based on the total volume of the fabric A. Multilayer hybrid composites with less than 80 vol % fibers selected from the group consisting of glass fibers and carbon fibers result in lower values for mechanical properties, such as stiffness and compressive strength. Multilayer hybrid composites with 100 vol % fibers selected from the group consisting of glass fibers and carbon fibers have better mechanical properties, such as stiffness. Preferably, the fabric A comprises from 100 to 80 vol % carbon fibers, the multilayer hybrid composite showing improved balance between structural strength, stiffness and impact strength, and little or no delamination between the layers of the composite.

The multilayer hybrid composite according to the present invention comprises at least one layer of each fabrics A and B, preferably at least two layers, more preferably at least three layers of each fabrics A and B. There is no limitation to a maximum number of layers in the multilayer composite as this may be dependent on the application of the composite and any practicalities. The composition of each of the fabrics A may be the same or different as the composition of the other fabrics A present in the composite. The composition of each fabrics B may be the same or different as the composition of the other fabrics B present in the composite.

The concentration of the fabric A may be from 99 to 1 vol % based on the total volume of the multilayer hybrid composite, preferably from 90 to 10 vol %, more preferably 40 to 60 vol %, based on the total volume of the multilayer hybrid composite.

At least one layer of the fabric B comprises from 20 to 70 vol % high performance polymer fibers, based on the total volume of the fabric B, and from 80 to 30 vol % fibers selected from a group consisting of glass fibers and carbon fibers, based on the total volume of the fabric B. Preferably, at least one layer of the fabric B comprises from 20 to 50 vol %, preferably 35 to 50 vol % high performance polymer fibers, based on the total volume of the fabric B. Higher amounts of high performance polymer fibers result in lower values for mechanical properties and poor adhesion between the layers of the composite and thus delamination. Lower amounts of high performance polymer fibers result in lower impact strength properties and decrease of penetration resistance (i.e. out-of-plane impact resistance).

Preferably, each one layer of fabric A in the multilayer hybrid composite according to the present invention comprises substantially the same amount of high performance polymer fibers and substantially the same amount of carbon fibers or glass fibers in each side of fabric A in one layer, i.e. on the back surface area and on the surface area of the fabric A of one layer or in another words in the outside and in the inside surface area of the fabric A. In this context, “substantially the same amount” means of from 45 vol % to 55 vol %, preferably of from 48 vol % to 53 vol % of each fiber based on the total volume of fibers in fabric A, i.e. of from 45 vol % to 55 vol % and preferably of from 48 vol % to 53 vol % of high performance polymer fiber and of from 45 vol % to 55 vol % and preferably of from 48 vol % to 53 vol % of glass fiber or carbon fiber, such that the total volume% of fibers adds up to 100 in each side of one layer of fabric A. Such a fabric construction may be also referred to herein as symmetrical fabric. This construction results in little or no delamination of the multilayer hybrid composite according to the present invention.

Preferably, the multilayer hybrid composite consists of one or more layers of the fabric A, one or more layers of the fabric B and the matrix. More preferably, the multilayer hybrid composite according to the present invention consists of i) one or more layers of the fabric A, ii) one or more layers of the fabric B and iii) a matrix, wherein the fabric A substantially consists or consists of glass fibers or carbon fibers, most preferably of high performance polymer fibers and carbon fibers and the fabric B substantially consists or consists of high performance polymer fibers and glass fibers or carbon fibers, preferably of high performance polymer fibers and carbon fibers.

Preferably, the total amount of the high performance polymer fibers in the multilayer composite according to the invention is between 10 and 50 vol %, more preferably between 10 and 30 vol % or 10 to 25 vol %, based on the total volume of the multilayer hybrid composite.

Fabrics A and B may have any construction known in the art. Preferably, fabric A, in case high performance polymer fibers are present, and/or fabric B comprise fibers selected from the group consisting of glass fibers and carbon fibers and high performance polymer fibers in weft and/or in warp directions, more preferably both types of fabrics, i.e. glass fibers or carbon fibers and high performance polymer fibers are in weft and warp directions. Such construction shows better structural properties. Other constructions of fabrics A and/or B may include fibers selected from the group consisting of glass fibers and carbon fibers in warp directions and high performance polymer fibers in weft direction or fibers selected from the group consisting of glass fibers and carbon fibers and high performance polymer fibers in warp direction and high performance polymer fibers in weft direction.

Preferably, fabric A and/or B in the composite according to the invention comprise the same or similar amount of high performance polymer fibers and fibers selected from the group consisting of glass fibers and carbon fibers in warp and weft directions. Such a symmetrical fabric construction shows better impact and strength in both directions of the fabric.

Preferably, the multilayer hybrid composite of the invention contains at least 2 fabrics of fabric A or B, more preferably at least 3 fabrics of fabric A or B, or at least 4 fabrics of fabric A or B, said fabrics being preferably stacked such that they overlap over substantially their whole surface area.

The areal density (AD) of the fabrics A and B is preferably between 10 and 2000 g/m². Other preferred ADs for the fabrics may be between 100 and 1000 g/m² or between 150 and 500 g/m².

At least one layer of the fabric B in the multilayer hybrid composite according to the present invention is adjacent to, i.e. superimposed on at least one layer of the fabric A. In other words, one layer of fabric B is adjacent to, i.e. superimposed or stacked on or in direct contact with one layer of fabric A (forming thus an AB or BA layer sequence in the composite construction). Preferably, one layer of the fabric B is adjacent to, i.e. interposed in-between, two layers of fabric A, forming at least one BAB layer sequence in the multilayer composite according to the present invention or, in case one layer of fabric B forms the outer surface of the multilayer hybrid composite, then said one layer of the fabric B is adjacent to one layer of fabric A.

The layers of the hybrid composite may be furthermore arranged in different manners. It is to be understood herein that when referring to layer(s) arrangement or stacking in the multilayer hybrid composite according to the invention, by at least one layer of a fabric is meant the surface, i.e. the upper surface or the lower surface, herewith interchangeable referred to, of the at least one layer of said fabric.

Preferably, the multilayer hybrid composite comprises at least one, preferably one layer of fabric A that is adjacent to, i.e. interposed or located in-between two layers of fabric B (e.g. the composite comprises at least one layer sequence BAB), for instance the multilayer hybrid composite comprises in its construction at least one of the following layer sequence: B(A)ₙB, with n being the number of layers of fabric A and an integer of at least 1, preferably of at least 1 to at most 20. Such a construction prevents delamination of the layers in the composite of the invention. At least one layer of fabric B, preferably one layer of fabric B may be adjacent to, i.e. interposed or located in-between two layers of fabric A (e.g. the composite comprises at least one layer sequence ABA) in the multilayer hybrid composite construction. The multilayer hybrid composite may also comprise at least one layer of fabric B, preferably one layer of fabric B and at least one layer of fabric A, preferably one layer of fabric A that may be arranged in an alternating manner (e.g. the composite comprises at least one layer sequence ABABAB). More preferred examples of such stacked layer constructions in the multilayer hybrid composite according to the invention include ABA, BAB, BABAB, ABABA, AABABAA, BAABABAAB and/or BAAAB, wherein A represents one layer of the fabric A and B represents one layer of the fabric B.

Most preferably, the multilayer hybrid composite according to the invention does not contain or in other words is free of two or more layers of fabrics B which are adjacent to each other, i.e. in other words, superimposed on or stacked onto each other or in direct contact surface area with each other, the multilayer hybrid composite being thus free of (B)ₙ layer(s) sequence, with n being the number of layers of fabric B and n being an integer of at least 2, preferably of at least 2 to at most 20. A multilayer hybrid composite having at least one (B)ₙ layers sequence in its construction, with n being the number of layers of fabric B and an integer of at least 2 is prone to delamination.

The layers of the multilayer hybrid composite according to the invention form preferably a stack, said stack having an upper-stack surface and a lower-stack surface opposite to the upper-stack surface. With respect to its location towards the outside and/or towards another layer, each layer of the multilayer hybrid composite typically has an upper surface (herein may also be referred to as “upper side”) and a lower surface (herein may also be referred to as “lower side” or “back surface”) opposite to the upper surface. It goes without saying that although called “upper” and “lower”, these denominations are not limiting and they may be interchangeable.

The length (L) and the width (W) of the multilayer hybrid composite according to the invention may widely vary, depending on the field where the composite is applied, e.g. the L and/or W may be in the centimeter range for small products like toys, household products or machine components, or meter range e.g. for cars and bicycles, to even 10 or 100 of meters for aircrafts rockers ships or bridges. The thickness of the multilayer hybrid composite of the invention can vary within wide ranges and is dictated by e.g. the number of said fabrics and/or by the processing conditions, e.g. pressure and time.

In the context of the present invention, “high performance polymer fibers” include fibers comprising a polymer selected from a group comprising or consisting of homopolymers and/or copolymers of alpha-olefins, e.g. ethylene and/or propylene; polyoxymethylene; poly(vinylidine fluoride); poly(methylpentene); poly(ethylene-chlorotrifluoroethylene); polyamides and polyaramides, e.g. poly(p-phenylene terephthalamide) (known as Kevlar®); polyarylates; poly(tetrafluoroethylene) (PTFE); poly{2,6-diimidazo-[4,5b-4′,5′e]pyridinylene-1,4(2,5-dihydroxy)phenylene} (known as M5); poly(p-phenylene-2, 6-benzobisoxazole) (PBO) (known as Zylon®); poly(hexamethyleneadipamide) (known as nylon 6,6); polybutene; polyesters, e.g. poly(ethylene terephthalate), poly(butylene terephthalate), and poly(1,4 cyclohexylidene dimethylene terephthalate); polyacrylonitriles; polyvinyl alcohols and thermotropic liquid crystal polymers (LCP) as known from e.g. U.S. Pat. No. 4,384,016 , e.g. Vectran® (copolymers of para hydroxybenzoic acid and para hydroxynaphtalic acid). Also combinations of such polymers can be used for manufacturing the composite according to the invention. Preferably, the high performance polymer fibers comprise a polyolefin, preferably an alpha-polyolefin, such as propylene homopolymer and/or ethylene homopolymers and/or copolymers comprising propylene and/or ethylene. The average molecular weight (M_{w}) and/or the intrinsic viscosity (IV) of said polymeric materials can be easily selected by the skilled person in order to obtain a fiber having desired mechanical properties, e.g. tensile strength. The technical literature provides further guidance not only to which values for M_{w} or IV a skilled person should use in order to obtain strong fibers, i.e. fibers with a high tensile strength, but also to how to produce such fibers.

The high performance polymer fibers have a tenacity of at least 1.5 N/tex, more preferably at least 2.5 N/tex, even more preferably at least 3.5 N/tex, and most preferably at least 4 N/tex. For practical reasons, the tenacity of the high performance polymer fibers may be at most 10 N/tex. The tenacity may be measured by the method as described in the Examples section herein below.

The tensile modulus of the high performance fibers may be of at least 20 GPa, more preferably at least 60 GPa, most preferably at least 80 GPa. The titer of the fibers may be at least 5 dtex, more preferably at least 10 dtex. For practical reasons, the titer of the fibers can be at most 10000 dtex, preferably at most 5000 dtex, more preferably at most 3000 dtex. Preferably, the titer of said fibers is in the range of 100 to 10000, more preferably 500 to 6000 and most preferably in the range from 800 to 3000 dtex. The tensile modulus and titer may be measured by the method as described in the Examples section herein below.

In the context of the present invention, “high strength polyethylene fibers” include fibers comprising a polymer selected from a group comprising or substantially consisting or consisting of ethylene homopolymers and/or ethylene copolymers, such as ethylene-alpha-olefin comonomers. Preferably, said high performance polyolefin fibers comprise a high performance polyethylene, and most preferably high molecular weight polyethylene (HMWPE) or ultrahigh molecular weight polyethylene (UHMWPE). In the context of the present invention “high performance” fiber term is interchangeable to “high strength” fiber or to “high modulus” fiber term.

By “UHMWPE” is herein understood a polyethylene having an intrinsic viscosity (IV) of at least 4 dl/g, more preferably at least 8 dl/g, most preferably at least 12 dl/g. Preferably said IV is at most 50 dl/g, more preferably at most 35 dl/g, more preferably at most 25 dl/g. Intrinsic viscosity is a measure for molecular weight (also called molar mass) that can more easily be determined than actual molecular weight parameters like Mn and M. The IV may be determined according to ASTM D1601(2004) at 135° C. in decalin, the dissolution time being 16 hours, with BHT (Butylated Hydroxy Toluene) as anti-oxidant in an amount of 2 g/l solution, by extrapolating the viscosity as measured at different concentrations to zero concentration. When the intrinsic viscosity is too low, the strength necessary for using various molded articles from the UHMWPE sometimes cannot be obtained, and when it is too high, the processability, etc. upon molding is sometimes worsen.

The high strength polyethylene fibers and preferably the UHMWPE fibers have a tenacity of at least 1.5 N/tex, preferably 2.0 N/tex, more preferably at least 2.5 N/tex or at least 3.0 N/tex. Tensile strength, also simply strength, or tenacity of the fibers are determined as also described in the experimental section herein. There is no reason for an upper limit of tenacity of high strength polyethylene fibers, but available said fibres typically are of tenacity at most about 5 to 6 N/tex.

The high strength polyethylene fibers and preferably the UHMWPE fibers have preferably a titer of at least 5 dtex, more preferably at least 10 dtex. For practical reasons, the titer of the fibers can be at most 10000 dtex, preferably at most 5000 dtex, more preferably at most 3000 dtex. Preferably, the titer of said fibers is in the range of 100 to 10000, more preferably 500 to 6000 and most preferably in the range from 1000 to 3000 dtex.

The tensile modulus of the high performance polyethylene fibers may be of at least 20 GPa, more preferably at least 60 GPa, most preferably at least 80 GPa or at least 100 GPa or even at least 150 GPa, determined as described in the experimental section herein. UHMWPE fibres typically have a high tensile modulus, e.g. of from 20 GPa to 200 GPa, determined as described in the Examples section herein.

The high strength polyethylene fibers preferably used in the multilayer hybrid composite according to the present invention may be manufactured according to any process known in the art, for example by a melt spinning process, a gel spinning process or a solid state powder compaction process. Preferably, the UHMWPE yarns comprise gel-spun fibers, i.e. fibers manufactured with a gel-spinning process. Examples of gel spinning processes for the manufacturing of UHMWPE fibers are described in numerous publications, including EP 0205960 A, EP 0213208 A1, U.S. Pat. No. 4,413,110, GB 2042414 A, GB-A-2051667, EP 0200547 B1, EP 0472114 B1, WO 01/73173 A1 and EP 1,699,954. The gel spinning process typically comprises preparing a solution of a polymer of high intrinsic viscosity (e.g. UHMWPE), extruding the solution into fibers at a temperature above the dissolving temperature, cooling down the fibers below the gelling temperature, thereby at least partly gelling the fibers, and drawing the fibers before, during and/or after at least partial removal of the solvent. The gel-spun fibers obtained may contain very low amount of solvent, for instance at most 500 ppm.

The fabric A and/or B may comprise UHMWPE fibers as described in documents WO2013087827 and WO2005066401, incorporated herein by reference or UHMWPE fibers comprising olefinic branches (OB). Such a UHMWPE comprising olefinic branches is for instance described in document WO2012139934, included herein by reference. The OB may have a number of carbon atoms between 1 and 20. The number of olefinic, e.g. ethyl or butyl, branches per thousand carbon atoms can be determined by FTIR on a 2 mm thick compression moulded film by quantifying the absorption at 1375 cm⁻¹ using a calibration curve based on NMR measurements as in e.g. EP 0 269 151 (in particular page 4 thereof). The UHMWPE also may have an amount of olefinic branches per thousand carbon atoms (OB/1000 C) of between 0.01 and 1.30. The yarns comprising UHMWPE comprising olefinic branches may be obtained by spinning an UHMWPE comprising olefinic branches and having an elongational stress (ES), and a ratio (OB/1000 C)/ES between the number of olefinic branches per thousand carbon atoms (OB/1000 C) and elongational stress (ES) of at least 0.2 and more preferably of at least 0.5. Said ratio can be measured wherein said UHMWPE fiber is subjected to a load of 600 MPa at a temperature of 70° C., has a creep lifetime of at least 90 hours. The elongational stress (ES in N/mm²) of an UHMWPE can be measured according to ISO 11542-2A.

The high strength polyethylene and more preferably branched UHMWPE may be obtained by any process known in the art. A suitable example of such process known in the art is a slurry polymerisation process in the presence of an olefin polymerisation catalyst at a polymerisation temperature. Said process may comprise, for instance, the steps of: a) charging a reactor, e.g. a stainless steel reactor with a-i) a non-polar aliphatic solvent having a boiling point at a temperature higher than the polymerization temperature. Said polymerisation temperature may be preferably between 50° C. and 90° C. The boiling point of said solvent may be between 60° C. and 100° C. Said solvent may be chosen from the group comprising heptane, hexane, pentamethylheptane and cyclohexane; a-ii) an aluminum alkyl as co-catalyst such as triethylaluminum (TEA) or triisobutylaluminum (TIBA); a-iii) a ethylene gas, to a pressure between 0.1 and 5 barg; a-iv) optionally an alpha-olefinic comonomer when branched UHMWPE is to be obtained; and iv) a catalyst suitable of producing a polyethylene, most preferably a UHMWPE under the conditions a)-i) to a)-iv), said catalyst being preferably a Ziegler-Natta catalyst. Ziegler-Natta catalysts are known in the art and are, for instance, described in WO 2008/058749 or EP 1 749 574 included herein by reference; then b) gradually increasing the ethylene gas pressure inside the reactor, e.g. by adjusting the gas flow, to reach a gas pressure of preferably at most 10 barg during the course of the polymerization process; and c) producing polyethylene and most preferably UHMWPE that may be in the form of powder or particles that may have an average particle size (D50) as measured by ISO 13320-1 of between 80 μm and 300 μm. The alpha-olefinic comonomer may be chosen with due regard to the type of branching required. For instance, in order to produce a polyolefin, preferably a polyethylene and most preferably UHMWPE having ethyl branches, the alpha-olefinic comonomer is butene, more preferably 1-butene. The ratio of gas:total ethylene (NL:NL) in case a polyethylene, preferably UHMWPE is used may be at most 325:1, preferably at most 150:1, most preferably at most 80:1; wherein by total ethylene is understood the ethylene added in steps a)-iii) and b). In order to produce a polyethylene and most preferably UHMWPE having butyl, e.g. n-butyl, or hexyl branches, the olefinic comonomer is 1-hexene or 1-octene, respectively.

Any glass and carbon fibers known in the art can be used according to the present invention. Glass fibers and carbon fibers are known in the art to be inorganic fibers. Suitable examples of glass fibers may include E-glaas, S-glass, basalt fibers, or the so-called Hypertex® fibers and all fibers that have in their composition Si, AL, O, Ca, and/or Mg, such that the sum of these elements is the majority of the mass of the glass like fibers. The carbon fibers or glass fibers may have a titer of between 500 and 40000 dtex, in particular between 650 and 32000 dtex and a filament count may be between 1000 and 48000.

In addition to the layers of fabrics A and B, the multilayer hybrid composite according to the present invention may comprise other types of layers mainly depending on the applications the composite is used for, e.g. foam layers.

The multilayer hybrid composite according to the present invention comprise a matrix material (iii). Any matrix material, e.g. based on thermoplastic or on thermoset polymers known to the skilled person in the art can be used. Preferred examples of the matrix material include a resin selected from the group comprising of an epoxy resin, a polyurethane resin, a vinylester resin, a phenolic resin, a polyester resin and/or mixtures thereof. The concentration of the matrix material is preferably from 70 to 30 vol %, more preferably from 60 to 40 vol % based on the total volume of the multilayer hybrid composite. Higher amount of matrix material adds disadvantageously to the total weight of the multilayer hybrid composite. Some voids may be present in the multilayer hybrid composite. Preferably, no voids are present in the multilayer hybrid composite according to the present invention. Any curing agent, e.g. epoxy resin based curing agents known in the art may be added to the matrix material by using any known method.

The matrix material may further comprise at least one additives known in the art, in any conventional amounts, such as various fillers, dyes, pigments, e.g. white pigment, flame-retardants, stabilizers, e.g. ultraviolet (UV) stabilizers, colorants. As commonly practiced in the art, such additives can be used to overcome common deficiencies of the fabric. The additives can be applied by any method already known in the art. The skilled person can readily select any suitable combination of additives and additive amounts without undue experimentation. The amount of additives depends on their type and function. Typically, their amounts are from 0 to 30 vol %, based on the total volume of the matrix material.

A binder can be additionally added to the individual fabric layers of the hybrid composite according to the invention. Binders are known to the skilled person in the art. Preferably, no binder is used according to the invention.

A pre-formed polymeric film may be also employed on the upper and/or lower surface (thus, located on the outside surfaces) of the multilayer hybrid composite according to the present invention. Preferably, said pre-formed polymeric film is manufactured from a polymeric material that is different, e.g. it belongs to a different polymeric class, than the polymeric material used to manufacture the fabrics in said composite as this may ease the removal of the pre-formed polymeric film. Preferred polymeric materials for manufacturing the pre-formed polymeric films may include polyvinyl-based materials, e.g. polyvinyl chloride, and silicone-based materials. By pre-formed polymeric film is herein understood a film manufactured from a polymeric material, wherein said film is freestanding, e.g. a sample of said film of e.g. 50 cm×50 cm does not break under its own weight when suspended at a height of double its highest dimension. Pre-formed polymeric films manufactured from the above-mentioned materials and having the above mentioned properties are commercially available. Moreover, the skilled person can easily produce such films with techniques commonly known in the art, e.g. extrusion, extrusion-moulding, solid-state compression or film-blowing, and stretch these films unidirectionally or bidirectionally to such an extent to obtain the required mechanical properties.

The multilayer hybrid composite according to the present invention can be made with any process known in the art. Suitable examples of known such processes include pre-impregnated fabrics process, hand lay-up, resin transfer molding or vacuum infusion process, autoclave process, press process.

Preferably, the multilayer hybrid composite according to the present invention is manufactured with a process comprising the steps of:

a) providing i) at least one layer of fabric A comprising from 0 to 20 vol % high performance polymer fibers, based on the total volume of the fabric A and from 100 to 80 vol % fibers selected from the group consisting of glass fibers and carbon fibers, based on the total volume of the fabric A, and ii) at least one layer of fabric B comprising from 20 to 70 vol % high performance polymer fibers, based on the total volume of the fabric B, and from 80 to 20 vol % fibers selected from the group consisting of glass fibers and carbon fibers, based on the total volume of the fabric B;
b) assembling the at least one layer of fabric A and the at least one layer of fabric B to form a stack, wherein the at least one layer of the fabric B is adjacent to the at least one layer of the fabric A, preferably wherein the surface of one layer of the fabric B is adjacent to the surface of one layer of the fabric A, more preferably the multilayer hybrid composite is free of (B)ₙ layers sequence, with n being the number of layers of fabric B and an integer of from at least 2, preferably of from at least 2 to at most 20;
c) applying a matrix material to the at least one layer of fabric A and the at least one layer of fabric B provided in step a) or applying a matrix material to the stack of step b), to obtain the multilayer hybrid composite,
wherein the concentration (vol %) of the high performance polymer fibers in the fabric B is higher than the concentration (vol %) of the high performance polymer fibers in the fabric A, and wherein the high performance polymer fibers have a tenacity of at least 1.5 N/tex.

The multilayer hybrid composite preferably has an upper surface and a lower surface, which is opposite to the upper surface. The term ‘adjacent layers’ means herein that the surface area of the layers are adjacent, i.e. the surface of each layer is superimposed on or stacked onto or in direct contact with the surface of another layer(s). Preferably the stacking of the layers is carried out such that said layers overlap over a major part of their surface, e.g. over more than 80% of their surface, preferably such that the layers overlap substantially over their entire surface.

The stack comprising layers of fabrics A and B may be formed by compressing the layers assembly at a pressure of between 0 and 50 bar, preferably at least 1 bar and at most 3 bar. Typically, a curing process may start at this step or at mixing the matrix step, e.g. mixing the resin with a curing agent. Any conventional pressing means may be utilized in the process of the invention e.g. autoclave, mold, e.g. matched die process.

The compressing in step c) and/or curing process and/or the post-curing process, in case carried out depending on the matrix system, and/or impregnation may take place starting at room temperature (e.g. 20° C.) until below the melting temperature of the high performance polymer fiber, as measured by DSC (step c). For instance, for high strength polyethylene fibers, said temperature is between room temperature and 100° C. below Tm as a starting temperature and 2° C. below Tm as a final temperature. Higher temperatures applied degrade the polymer fibers. In particular, in case of UHMWPE fibers, the room temperature or a temperature of preferably between 50° C. and 150° C., more preferably between 80° C. and 145° C. may be chosen. Alternatively, a stack of fabrics a) and b) containing a matrix material, preferably a resin may be supplied to a preheated press, being heated to a temperature below the melting temperature of the polymer fibers.

The matrix is typically applied to the stack or to the individual layers of step c) by impregnation using any method known in the art, e.g. by dipping the stack of layers or the individual layers in a resin bath. The matrix is preferably a resin in fluid form. In case the resin is a thermoplastic resin, impregnation takes place at a temperature below the melting temperature of the high performance polymer. After application of the resin, the resin is typically solidified. Before impregnation, the individual layers or the stack of layers may be put in a vacuum bag to release the air from the stack or individual layers.

The matrix preferably has a modulus in the hardened (solidified) state of between 1.5 and 8 GPa. The upper modulus values of this range side can only be obtained by special resins like melamine-formaldehyde resins as matrix. The lower modulus values are obtained when toughened resins are used as matrix. Such toughening is not necessary for the present composites, because the fiber hybridization provides all toughening needed. Preferably, the modulus of the matrix, e.g. solidified resin is between 2 and 5 GPa and most preferably between 3 and 4 GPa, the modulus being measured according to the method in the Examples section herein.

After forming, the multilayer hybrid composite may be cooled at room temperature, after which the pressure may be released.

The present invention also relates to an article comprising the multilayer hybrid composite according to the present invention. Said article shows an improved combination of properties and balance between structural strength, stiffness and impact strength, and little or no delamination between the layers of the composite.

Furthermore, the present invention directs to the use of the multilayer hybrid composites according to the present invention in various application fields, such as automotive (e.g. wheel rims for cars and motorcycles, parts of the structural car chassis, bumper beams, interiors for cars, impact panels), aerospace (e.g. aircrafts, satellites), sports equipment (e.g. bicycles frames, cockpits, seats, hockey sticks, tennis and squash rackets, ski and snowboards, surfboards, paddle boards, helmets such as for cycling, football, climbing, motorsport), marine (e.g. boat hulls, masts, sails, boats), military, wind and renewable energy (e.g. wind turbines, tidal turbines). Also various pieces of equipment, like suitcases and containers can be made with the multilayer hybrid composite according to the invention. When the multilayer hybrid composite according to the present invention is used in various applications, these applications show an improved combination properties and balance between structural strength, stiffness and impact strength, and shows little or no delamination between the layers of the composite comprised in these applications.

It is noted that the term ‘comprising’ does not exclude the presence of other elements. However, it is also to be understood that a description on a product comprising certain components also discloses a product consisting of these components. Similarly, it is also to be understood that a description on a process comprising certain steps also discloses a process consisting of these steps.

The invention will be elucidated below with the aid of a number of examples without being limited thereto.

### EXAMPLES

### Methods of Measuring

Dtex: yarn's or filament's titer was measured by weighing 100 meters of yarn or filament, respectively. The dtex of the yarn or filament was calculated by dividing the weight (expressed in milligrams) to 10.
IV: the Intrinsic Viscosity is determined according to method ASTM D1601(2004) at 135° C. in decalin, the dissolution time being 16 hours, with BHT (Butylated Hydroxy Toluene) as anti-oxidant in an amount of 2 g/l solution, by extrapolating the viscosity as measured at different concentrations to zero concentration.
Tensile properties of fibers: tensile strength (or strength) and tensile modulus (or modulus) are defined and determined at room temperature, i.e. about 25° C. on multifilament yarns as specified in ASTM D885M, using a nominal gauge length of the fibre of 500 mm, a crosshead speed of 50%/min and Instron 2714 clamps, of type “Fibre Grip D5618C”. On the basis of the measured stress-strain curve, the modulus is determined as the difference between 0.3 and 1% strain. For calculation of the modulus and strength, the tensile forces measured are divided by the titer, as determined above; values in GPa are calculated assuming a density of 0.97 g/cm³ for the UHMWPE.
E-modulus, flexural modulus of the multilayer hybrid composite samples and of the matrix was measured according to standard method ISO-178 at room temperature, i.e. about 25° C. All tests for determining the modulus were conducted at test speeds of 1 mm/min. The width of the test specimens was 25±0.5 mm. The L/h (length/thickness) ratio for all test specimens was 24. The radius of the loading edge was 5 mm. The radius of the supports was 2 mm. The modulus was determined by taking the steepest slope of the flexural stress−flexural strain curve (stress [MPa] on y axis, strain on x axis) obtained after each test. The thickness of the samples was measured at various places on the
Areal Density (AD) is obtained by weighing a certain area of a sample and dividing the obtained mass by the area of the sample (kg/m²).
Delamination was determined by visual inspection of the sample.
Impact strength was measured at room temperature, i.e. about 25° C. on a 40×40 cm² rectangular panel of thickness t that was placed on a steel metal frame with a rectangular aperture of dimension 32×32 cm². Along the perimeter, three 8 mm bolts per side (2 cm from the edge) were used to clamp the panel between the upper and lower part of the frame. Below the panel was placed an airgap. A hemispherical dart with 5 mm radius and mass m=4.93 kg was used to test the penetration resistance by varying the initial height h. Each plate was tested by 6 impacts with varying initial height h to generate penetrations and stops. The absorbed energy (Eabs) is defined as the energy E=m*g*h corresponding to the largest height h in vertical direction above the panel surface at which the plate was not penetrated, with g=9.81 m/s² denoting the gravitational acceleration. Impact locations are selected not to involve already hit primary yarns and equally spaced with maximum distance to each other and to the edges.

### Fabric A

A plain single layer woven fabric A was produced from warp yarns and weft yarns of 100 vol % carbon fibers, based on the total fabric A composition, the carbon fibers being commercially available under the tradename Toray T3003K from Toray having a titer of 2000 dtex. AD of the fabric A was 300 g/m².

### Fabric B

A plain single layer woven fabric B was produced from warp yarns and weft yarns in a 2/2 twill arrangement and 6.0 threads per cm. The fabric consists of 45 vol % UHMWPE fiber commercially available as Dyneema® SK75 (having a titer of 1760 dtex and a tenacity of 3.3 N/tex) and 55 vol % carbon fibers commercially available as Toray T3003K, the vol % being based on the total fabric B composition. The weft and the warp yarns comprise Dyneema® SK75 fibers and carbon fibers in a yarn ratio of 1:2 in the woven fabric B. AD of the fabric B was 235 g/m².

The layers comprising the fabrics A and/or B obtained as shown herein above were then each cut on size and stacked in different multilayer hybrid constructions as shown in Table 1 and the Examples and Comparative Examples herein below. Each stack of layers was put in a vacuum plastic bag that had an inlet and an outlet, in order to remove all the air from the stack and then placed on an infusion table for subsequent impregnation with a resin. A flow medium (commercially available as Compoflex RF150 purchased from Fibertex that is a fabric based on polypropylene that helps the resin flowing through the stack) was added to the vacuum bag, as well as spiral tubes for both inlet and outlet of the vacuum bag were placed to seal the infusion table. The infusion table was then left for 30 min at room temperature to degas under vacuum and to remove the moisture from the fabrics.

A mixture of an epoxy resin that is known under the commercial name EPIKOTE resin 04908/1 with EPIKURE Curing Agent 04908 commercially available from Hexion was employed as the resin matrix. Before infusion, the resin was degassed in a vacuum chamber to remove all air. The impregnation process of the stack of layers comprising the fabrics A and/or B with the resin took place at a temperature of 40° C. and an absolute pressure of 0.01 bar (vacuum). After full saturation of the fabrics (meaning that each layer of the stack was impregnated with the resin in such a way that the stack contained no voids), the inlet of the bag was closed and the infusion table was heated to a temperature of 70° C. Then, polyurethane plates were placed on top of the table to cover the stack. The multilayer hybrid composites so formed were left to cure for 16 hours at a temperature of 70° C.

### Example 1

A multilayer hybrid composite was formed by stacking 6 layers comprising fabrics A and B and then impregnating the stack obtained as described herein above and then forming a multilayer hybrid composite comprising the following layers of woven fabrics in the following layer sequence: ABABAB. The composition of the multilayer hybrid composite obtained was 50 vol % resin, 50 vol % of total volume of fabrics A and B, 15 vol % UHMWPE fibers and 35 vol % carbon fibers, each based on the total volume of the multilayer hybrid composite. The results are reported in Table 1.

### Comparative Example 1

A multilayer hybrid composite was formed by stacking 6 layers comprising fabric B and then impregnating the stack obtained as described herein above and then forming a multilayer hybrid composite comprising the following layers woven fabrics in the following layer sequence: BBBBBB. The composition of the multilayer hybrid composite obtained was 22.5 vol % UHMWPE fibers and 27.5 vol % carbon fibers and 50 vol % resin, each based on the total volume of the multilayer hybrid composite. The results are reported in Table 1.

### Comparative Example 2

A multilayer hybrid composite was formed by stacking 6 layers comprising fabric A and then impregnating the stack obtained as described herein above and then forming a multilayer hybrid composite comprising the following layers of woven fabrics in the following layer sequence: AAAAAA. The composition of the multilayer hybrid composite obtained was 50 vol % carbon fibers and 50 vol % resin, each based on the total volume of the multilayer hybrid composite. The results are reported in Table 1.

TABLE 1

| | Comp. Ex. 1 | Comp. Ex. 2 | Ex. 1 |
|---|---|---|---|
| Length sample, mm | 600 | 600 | 600 |
| Width sample, mm | 500 | 500 | 500 |
| Thickness sample, mm | 2.1 | 2.55 | 1.87 |
| AD, g/m² | 265 | 348 | 232 |
| UHMWPE fiber in total | 22.5 | 0 | 11.3 |
| composite composition, | | | |
| vol % | | | |
| Emod, GPa | 32.94 | 40.59 | 33.60 |
| Fmax, GPa | 0.32 | 0.64 | 0.48 |
| Impact Energy, J | 19.36 | 12.1 | 14.52 |
| Eabs, J | 7.30 | 3.50 | 6.25 |
| Fmax/AD | 0.123 | 0.185 | 0.206 |
| E-modulus/AD | 12.42 | 11.67 | 14.45 |

The results presented in Table 1 show that the multilayer hybrid composites according to the present invention (Example 1) show the best balance of good structural strength and good impact strength. On the other hand, the Comparative Examples show poor structural strength (Comparative Example 1) and low impact strength (Comparative Example 2). Also, no delamination of layers was observed in the composite according to Example 1. However, delamination for the layers was observed for the composites obtained according to Comparative Examples 1 and 2.

1. A multilayer hybrid composite comprising:
i) at least one layer of a fabric A comprising
from 0 to 20 vol % high performance polymer fibers, based on the total volume of the fabric A, and
from 100 to 80 vol % fibers, based on the total volume of the fabric A, said fibers being selected from the group consisting of glass fibers and carbon fibers;
ii) at least one layer of a fabric B comprising
from 20 to 70 vol % high performance polymer fibers, based on the total volume of the fabric B, and
from 80 to 30 vol % fibers, based on the total volume of the fabric B, said fibers being selected from the group consisting of glass fibers and carbon fibers; and
iii) a matrix material,
wherein the at least one layer of the fabric B is adjacent to the at least one layer of the fabric A, and
the concentration (vol %) of the high performance polymer fibers in the fabric B is higher than the concentration (vol %) of the high performance polymer fibers in the fabric A, and
the high performance polymer fibers have a tenacity of at least 1.5 N/tex.

2. The multilayer hybrid composite of claim 1, wherein the at least one layer of the fabric B contains from 20 to 50 vol % of high performance polymer fibers, based on the total volume of the fabric B.

3. The multilayer hybrid composite of claim 1, wherein fabrics A and B are woven fabrics or non-woven fabrics, preferably woven fabrics.

4. The multilayer hybrid composite of claim 1, wherein the high performance polymer fibers are high strength polyethylene fibers, preferably ultrahigh molecular weight polyethylene fibers.

5. The multilayer hybrid composite of claim 1, wherein woven fabric B comprises carbon fibers or glass fibers and high strength polyethylene fibers in the weft and in the warp directions.

6. The multilayer hybrid composite of claim 1, wherein the concentration of the matrix is from 70 to 30 vol %, preferably from 60 to 40 vol % based on the total volume of the multilayer hybrid composite.

7. The multilayer hybrid composite of claim 1, said composite consisting of one or more layers of the fabric A, one or more layers of the fabric B and the matrix material.

8. The multilayer hybrid composite of claim 1, wherein the composite comprises at least one layer sequence ABA with one layer of fabric A located in-between two layers of fabric B or at least one layer sequence AB with one layer of fabric A adjacent to one layer of fabric B in case layer B forms the outside surface of the composite.

9. The multilayer hybrid composite of claim 1, wherein the composite is free of (B)ₙ layer sequence, with n being the number of layers of fabric B and n being an integer of at least 2, preferably of at least 2 to at most 20.

10. The multilayer hybrid composite of claim 1, having at least one layer sequence of ABA, BAB, BABAB, ABABA, AABABAA, BAABABAAB and/or BAAAB in the construction, wherein A represents one layer of the fabric A and B represents one layer of the fabric B.

11. The multilayer hybrid composite of claim 1, wherein the matrix material has a E-modulus in the range of from 2 GPa to 8 GPa, preferably of from 3 GPa to 5 GPa.

12. The multilayer hybrid composite of claim 1, wherein the matrix material is a thermoplastic or a thermoset resin, preferably selected from a group comprising an epoxy resin, a polyurethane resin, a polyester resin, a vinylester resin, a phenolic resin, and/or mixtures thereof.

13. Process for making the multilayer hybrid composites of claim 1, the process comprising the steps of:
a) providing i) at least one layer of fabric A comprising from 0 to 20 vol % high performance polymer fibers, based on the total volume of the fabric A and from 100 to 80 vol % fibers selected from the group consisting of glass fibers and carbon fibers, based on the total volume of the fabric A, and ii) at least one layer of fabric B comprising from 20 to 70 vol % high performance polymer fibers, based on the total volume of the fabric B, and from 80 to 20 vol % fibers selected from the group consisting of glass fibers and carbon fibers, based on the total volume of the fabric B;
b) assembling the at least one layer of fabric A and the at least one layer of fabric B to form a stack, wherein the at least one layer of the fabric B is adjacent to the at least one layer of the fabric A;
c) applying a matrix material to the at least one layer of fabric A and the at least one layer of fabric B provided in step a) or applying a matrix material to the stack obtained in step b), to obtain the multilayer hybrid composite,
wherein the concentration (vol %) of the high performance polymer fibers in the fabric B is higher than the concentration (vol %) of the high performance polymer fibers in the fabric A, and wherein the high performance polymer fibers have a tenacity of at least 1.5 N/tex.

14. An article comprising the multilayer hybrid composite according to claim 1.

15. Use of the multilayer hybrid composites of claim 1 in automotive, aerospace, sports equipment, marine, military, wind and renewable energy fields.
